(19) United States
(12) Patent Application Publication
(10) Pub. No.: US 2001/0016899 A1
(43) Pub. Date: Aug. 23, 2001

(54) Data-processing device

(76) Inventor: Xiaoning Nie, Munchen (DE)

Correspondence Address: LERNER AND GREENBERG, P.A., Post Office Box 2480, Hollywood, FL, 33022-2480, US

(21) Appl. No.: 09/760,405

(22) Filed: Jan. 12, 2001

(30) Foreign Application Priority Data
Jan. 12, 2000 (DE) 100 00 960.3

(51) Int. Cl. G06F 9/30

(52) U.S. Cl. 712/215; 712/206; 712/210

(57) ABSTRACT

A data-processing device, in particular a network processor for processing layer 1 to 7 of protocol stacks in applications such as LAN, ATM switches, IP routers or frame relays which are based on DSL, Ethernet or cable modems. The processor has instruction buffers, instruction decoders, and instruction-execution units corresponding to a number of processes to be processed in parallel. A program flow control unit essentially controls the parallel processing.

### BACKGROUND OF THE INVENTION

### FIELD OF THE INVENTION

The invention relates to a data-processing device for parallel processing at least two independent processes (threads).

U.S. Pat. No. 5,941,983 discloses a data-processing device for parallel processing independent processes with a program memory in which a compiled program with a multiplicity of independent processes (threads) is stored, the compiled program comprising information relating to parallelism and a multiplicity of bundles with a plurality of instructions of a process.

International PCT publication WO 99/21088 discloses a data-processing device for parallel processing processes (threads) with a thread switching logic which comprises registers for storing flags and data.

U.S. Pat. No. 5,404,469 discloses a data-processing device (multi-threaded microprocessor) which uses a static nesting technique.

The throughput rate and the speed of a data-processing device or of a processor can, as is known, be raised by pipelining and by increasing the clock frequency.

It is also possible to raise the data processing rate by increasing the expenditure on hardware, i.e. by increasing the number of units of the processor. For this purpose, essentially two concepts are known, specifically multi-processor architecture and parallelism on the instruction level of the processor (ILP=instruction level parallelism).

Nowadays ILP has become widely established as a concept for parallel processing. In contrast, multi-processor architecture is less successful owing to the complicated interprocessor communication.

An example of the ILP concept is the VLIW (Very Large Instruction Word) architecture of the digital signal processors of the C6x series from Texas Instruments. The new IA-64 architecture from Intel and Hewlett Packard is also based on the ILP concept. In the two aforementioned architectures, parallelism is detected during the transfer of the program code. Intel refers to its IA-64 architecture as “Explicit Parallel Instruction Computing” (EPIC). During the transfer, a number of predefined flags are set in order to detect the parallelism. As a result, the processor can detect easily when instructions which are to be carried out in parallel occur in the program flow and react appropriately. In addition, this is cheaper than, for example, providing hardware in duplicate, as in the case of complete parallelism, which is used in the superscalar architectures of the PowerPC processors. In these processors parallelism is not detected until during the program running time, and then there is an appropriate reaction to it. The gain by virtue of using ILP is, however, restricted by the inherent dependencies of the data operations and control operations. In order to avoid such dependencies, complex preprocessing for example taking into account data and control operation dependencies during the actual programming—is necessary and this in turn makes the entire development process more expensive.

In the paper “Simultaneous Multithreading: Maximizing On-Chip Parallelism” by Tullsen, Eggers, and Levy, published in the Proceedings of 22nd Annular Int'l Symposium for Computer Architectures, 1995, simultaneous multithreading is proposed in order to maximize parallelism on the chip level. To achieve this, a plurality of independent processes, instruction sequences or program flows (threads) are output to the units, present in multiple form, of a superscalar processor in a clock cycle. The object of the simultaneous multithreading is to relieve the loading on all the units of a processor simultaneously by using parallelism, and thus, inter alia, to reduce the effects on the processor performance of long latency times, which are caused by a slow memory.

A single-chip multiprocessor is described in the paper “A single-chip Multiprocessor” by Hammond, Nayfeh, and Olukotun, published in 1997 in IEEE Computer pages 79 to 85. That paper deals in particular with the differences between simultaneous multithreading (SM) and chip multiprocessors (CMP) in terms of performance. In addition, it is proposed to use a multiprocessor architecture for processing parallel processes owing to the rapidly increasing integration density of integrated circuits.

### SUMMARY OF THE INVENTION

The object of the present invention is to provide a data processing system and device which overcomes the above-noted deficiencies and disadvantages of the prior art devices and methods of this general kind, and wherein the data-processing device or the processor can carry out two processes (threads) in parallel, and wherein the hardware expenditure is relatively low.

With the above and other objects in view there is provided, in accordance with the invention, a data-processing device for parallel-processing a plurality of independent processes, comprising:

a program memory having stored therein at least one compiled program with a multiplicity N of independent processes, the compiled program including information on parallelism and a multiplicity of bundles with a plurality of instructions of a process;

a branching control unit connected to and addressing the program memory;

a register for storing flags and data which are switched in dependence on a process being executed; and

a program flow control unit connected to the branching control unit, the program flow control unit controlling a fetching of bundles from the program memory and the branching control unit and an output of instructions in dependence on information contained in the instructions and included in a compiling time of the program.

Such a data-processing device can be used advantageously, for example, in telecommunications applications as the network processor for handling layers 1 to 3 of the protocol stack of LAN applications, in ATM (Asynchronous Transfer Mode) switches, in IP (Internet Protocol) routers or frame relays which are based, in particular, on DSL (Digital Subscriber Line) methods, Ethernet and cable modems. In particular in the above-mentioned applications, independent processes for processing different functions, for example different protocols, frequently occur. Such processes which are referred to as multiple threads and which occur in parallel are correspondingly widespread in the telecommunications area as basic applications. In a programmable IP/ATM interface (Internet Protocol. Asynchronous Transfer Mode - Input/Output - Processing Unit), independent processes for controlling different data connections or for controlling separate data-shifting operations occur, for example.

The use of the data-processing device according to the invention is, however, not restricted to the above-mentioned applications, but can be used wherever parallel processes occur. Examples of this are, for example, open-loop and closed-loop control functions or quite generally in computers for business or domestic use. The use of a data-processing device is particularly appropriate if processors have to be processed generally in parallel with a high performance level.

The basic idea of the invention is that the dependencies of data and instructions in independent processes running in parallel are smaller than in an individual program flow (single sequential program flow) for parallel processing. When a program is transferred or compiled in machine code, the program is examined for parallelism and provided with special flags or information for indicating parallelism.

The architecture of the data-processing device is, in this respect, compatible with a single program architecture (single thread architecture). The instructions which are to be carried out in parallel are fetched from a program memory according to a clock cycle. Each individual parallel process is assigned a priority. After the fetch phase in which the data-processing device fetches data and instructions from the program memory via a branching control unit, a program flow control unit decides which process will be carried out first in accordance with the assigned priority and the flags set during the transfer and/or information relating to parallelism which is included.

For this purpose, the data-processing device has registers for storing the status variables of the parallel programs such as program counters, register files, ALU (arithmetic logic unit) flags etc. The registers can be switched as a function of the process which is to be processed, and serve essentially for storing data of the process (so-called context switch).

In accordance with an added feature of the invention, a number N instruction buffers are connected in parallel downstream of the program memory for storing instructions read out from the program memory.

In accordance with an additional feature of the invention, an instruction output selector is connected to and controlled by the program flow control unit such that the instruction output selector reads out instructions from the instruction buffers and outputs N instructions in parallel.

In accordance with another feature of the invention, N instruction decoders are provided for decoding the instructions being output.

In accordance with a further feature of the invention, at least two instruction-execution units are provided for outputting the N decoded instructions.

In accordance with again an added feature of the invention, there is provided a data memory and at least two buses connecting the N instruction-execution units to the data memory.

In accordance with again an additional feature of the invention, the program flow control unit is configured to execute the instructions of one or more bundles in parallel.

In accordance with again another feature of the invention, the branching control unit is configured to output an address pointer for addressing a bundle.

In accordance with a further feature of the invention, the branching control unit comprises:

a first multiplexer and a second multiplexer;

an adder; and

N program counters; and

the program flow control unit feeds a number of instructions in a bundle to the adder and the adder adds an address pointer and the number of instructions;

the program flow control unit feeds addresses for program jumps or function calls and a process number to the first multiplexer;

the first multiplexer writes either the output signal of the adder or the addresses for program jumps or function calls into the program counter assigned to the active process; and

a content of the program counter assigned to the currently active process is output as a new address pointer via the second multiplexer which is controlled using the process number supplied.

In accordance with yet a further feature of the invention, the program flow control unit is configured to receive via a subbus of an output bus of the program memory:

at least one bit for indicating the parallel execution of instructions; and/or

at least one bit for indicating the length of the following instruction bundle; and/or

the indication of one or more NOPs in the instruction bundles; and/or

a priority of the processes of the instructions.

In accordance with a concomitant feature of the invention, a process is called by assigning a process number, a priority and a memory address of a starting point of the process in the program memory.

An instruction output selector is preferably controlled by the program flow control unit in such a way that the latter reads out instructions from the instruction buffers and outputs N instructions in parallel.

For the parallel processing, central units such as instruction decoders and program counters may be provided multiply, for example in duplicate, in the branching control unit as a function of the active parallel processes. In this respect it is not necessary to provide additional units for each parallel process, but rather only as many as the number of processes which are to be carried out in parallel simultaneously. Therefore, if a program has, for example, five different parallel processes but only two of these five processes are ever active, it is sufficient to provide the central units in duplicate. In comparison to the costly ILP architectures, there is an overall smaller hardware requirement. The units for fetching the instructions (instruction buffers and instruction output selectors) and for branching (branch control units) have a particular design in order to process the parallel processes. The proposed architecture can be used either with or without a program cache and data cache.

A process is preferably called by assigning a process number, a priority and a memory address starting from which the process is stored in the program memory.

The data-processing device preferably serves as a network processor for processing layer 1 to 7 of protocol stacks in applications such as LAN, ATM switches, IP routers or frame relays which are based on DSL, Ethernet or cable modems. In particular in these applications, parallel processing is of essential importance so that the data-processing device according to the invention can be used particularly advantageously.

Other features which are considered as characteristic for the invention are set forth in the appended claims.

Although the invention is illustrated and described herein as embodied in a data-processing device it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block circuit diagram of the data-processing device according to the invention;

FIG. 2 is a block circuit diagram which represents in detail the nesting of the program memory, the program flow control unit and the instruction issue selector;

FIG. 3 is a block circuit diagram with the branching control unit; and

FIG. 4 is a status diagram explaining the method of operation of the program flow control unit.

### DESCRIPTION OF THE PREFERRED EMBODIMENTS

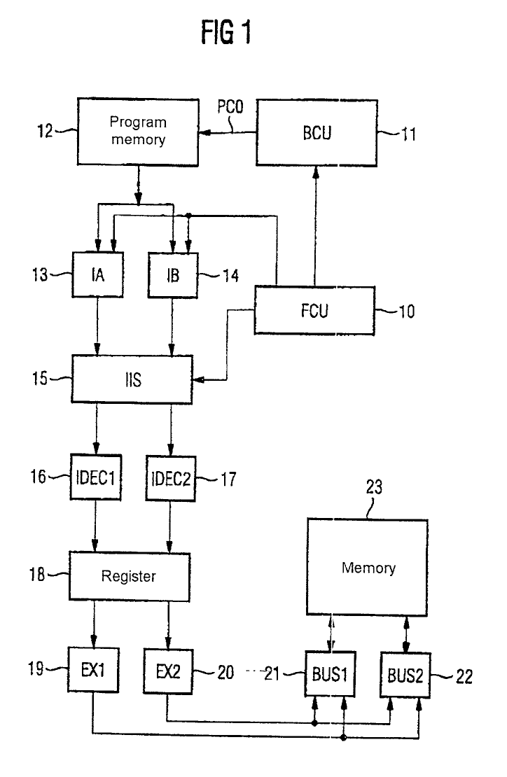

Referring now to the figures of the drawing in detail and first, particularly, to FIG. 1 thereof, there is seen a block circuit diagram of the data-processing device for parallel processing two processes or threads. A program stored in a program memory 12 is addressed by a branching control unit BCU 11 by means of an address pointer PC0. At least two program counters for various processes or threads are provided in the BCU 11. These program counters are assigned to the currently active processes. Depending on which process is currently running, i.e. is being processed by the data-processing device, the content of the respective program counter is used as address pointer PC0.

Two instruction buffers IA 13 and IB 14 for the two processes which are to be processed in parallel are connected downstream of the program memory 12. The instruction buffers store the instructions read out of the program memory.

A flow control unit FCU 10 controls both the BCU 11 and the instruction buffers 13 and 14. An instruction issue selector 15, by means of which instructions from the instruction buffers 13 and 14 are multiplexed to two instruction decoders 16 and 17, is connected downstream of the instruction buffers 13 and 14.

The instruction decoders 16 and 17 are provided with registers 18 for storing zero, carry and overflow flags for the processes running in parallel. The registers 18 have at least two register files for storing data and states of the active processes.

Two execution units EX1 19 and EX2 20 (instruction execution units) are in turn connected downstream of the register 18. These two units serve to execute the instructions. For this purpose, both units EX1 19 and EX2 20 are each provided with two buses BUS1 21 and BUS2 22 via which a memory 23 in which data is stored is accessed. The memory 23 is preferably a random access memory (RAM).

The method of operation of the configuration described above is explained below:

The program code is encoded in a fixed length. The programs of the processes are not necessarily separated but rather can also be combined in one program. The starting point of a process or thread corresponds to a jump combined with an additional function for setting a process or thread number. The format of such a starting point is as follows:

RUN Thread_nr Priority Jump_Adr

The process is therefore called with the instruction RUN, a thread number Thread_nr, a priority and the jump address Jump_Adr at which the process code is located in the program memory are also specified or assigned.

The instructions are always stored in bundles comprising one or two instructions. At the time of compilation, the ILP is examined in such a way that the bundles comprising instructions can be executed in parallel. This means that during the compilation of the program or programs an examination is conducted to determine which instructions are largely independent of one another and can accordingly be executed in parallel. Two independent instructions are then “packaged” into a bundle. In addition, the instructions from different bundles can also be executed in parallel. At any rate, the instructions of a bundle can thus be executed in parallel and, if appropriate, the instructions from different bundles or different processes can be executed in parallel. Each bundle has a flag which specifies the length of the following bundles. The address pointer is calculated as a function of this flag. During the addressing of the program memory 12 by means of the address pointer PC0, the latter has a bit width with which the maximum length of an instruction bundle can be addressed.

The instructions are fetched from the program memory (Instruction Fetch) in the following way: the program memory 12 is addressed by the address pointer PC0 (to do this the address pointer PC0 points to the starting address of a bundle); an instruction bundle is then read into one of the instruction buffers 13 or 14. Subsequently, a further instruction bundle is read out and written into the other one of the instruction buffers 13 or 14. The second instruction bundle is associated here with a different process from the first instruction bundle. In this way, two active processes can be processed. Overall, there may be more than two processes but in this exemplary embodiment the processor can only execute two active processes in parallel. By providing multiple examples of the respective instruction buffer, instruction decoder and execution units, it is also possible for more than two processes to be active, i.e. processed in parallel. During each fetch cycle, in each case two instruction bundles are transmitted from the program memory 12 into the instruction buffers 13 and 14.

Instructions from the instruction bundles or NOPs (No operations) are output from the instruction buffers 13 and 14 by means of the instruction issue selector 15 which comprises multiplexer logic. The instructions or NOPs are fed to the instruction decoders 16 and 17 for decoding. Either two instructions may be selected from one instruction bundle, i.e. two instructions from the instruction buffer 13 or 14, or in each case one instruction may be selected from the instruction buffer 13 and one from the instruction buffer 14 by means of the instruction issue selector 15. If the instructions which are output by the instruction issue selector 15 are NOPs, the processor can go into a power-down mode.

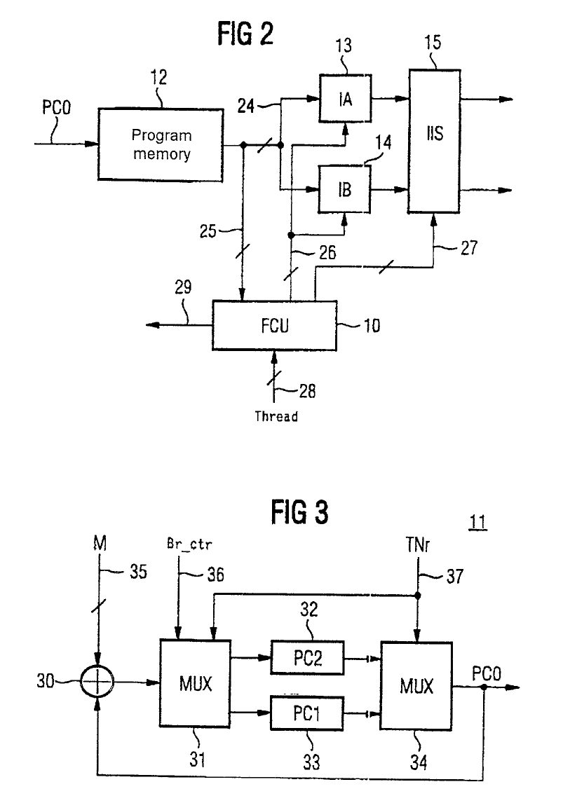

The outputting and selection of the instructions from the instruction buffers 13 and 14 and the instruction issue selector 15 is controlled by the flow control unit 10. This will be explained with reference to FIG. 2. The instruction bundles which are read out from the program memory 12 are fed to the instruction buffers 13 and 14 via an instruction bus. The following information from the instruction bundle is fed to the flow control unit 10 via an instruction subbus 25:

A bit for indicating the parallel execution of instructions or a bit for indicating the length of the following instruction bundle. However, in the case of program code with a fixed length it is not necessary to indicate the length.

The indication of one or more NOPs in the instruction bundles, in which case an NOP can be replaced by another instruction of the other process.

The current process, i.e. the number of the process via a thread bus 28.

The priority of the two processes.

The flow control unit 10 controls the instruction buffers 13 and 14 via a Fetch_Ctr bus 26, and the instruction issue selector 15 via an Issue_Select bus 27. The internal states of the flow control unit 10 show the number of remaining instructions in the instruction buffers 13 and 14 of the two processes. The flow control unit 10 outputs the following output signals:

A signal 29 for incrementing the program counter. The signal is output at the output line 29 and it is 0 for an instruction bundle comprising one instruction, and 2 for an instruction bundle comprising two instructions.

A Fetch_Ctr signal for enabling the instruction buffers 13 and 14 via the Fetch_Ctr bus 26.

An Issue_Select signal for controlling the instruction issue selector 15 via the Issue_Select bus 27.

The instruction decoders 16 and 17 which are connected downstream of the instruction issue selector 15 decode the instructions supplied. The process number and the priority of the respective process are stored in the register 18.

The design of the branching control unit 11 is illustrated in FIG. 3. The branching control unit 11 has an adder 30 which adds the address pointer PC0 and a signal M supplied via an instruction bundle bus 35. The signal M is either 1 for an instruction bundle comprising one instruction or 2 with an instruction bundle comprising two instructions. As a result, the current program counter value is incremented either by 1 or 2, that is to say as a function of whether an instruction bundle comprising one or two instructions is read. The output value of the adder 30 is fed to a first multiplexer 31. The first multiplexer 31 either switches the signal supplied by the adder 30 or signals supplied via a Br_Ctr bus 36, for controlling jumps and function calls, to one of two program counters 32 and 33. Which of the program counters is written to depends on the process number TNr supplied via a thread bus 37. A program counter is assigned to each of the two active processes. Therefore, if, for example, an instruction bundle comprising two instructions of the process with the number 4 is read out of the program memory, the signal M is equal to 2 and the first multiplexer writes a value PCO+2 into the program counter PC1 33 which is assigned to the process with the number 4. One of the two program counters 32 and 33 is output as address pointer PC0 via a second multiplexer 34. The process number in turn controls which of the two program counters is output.

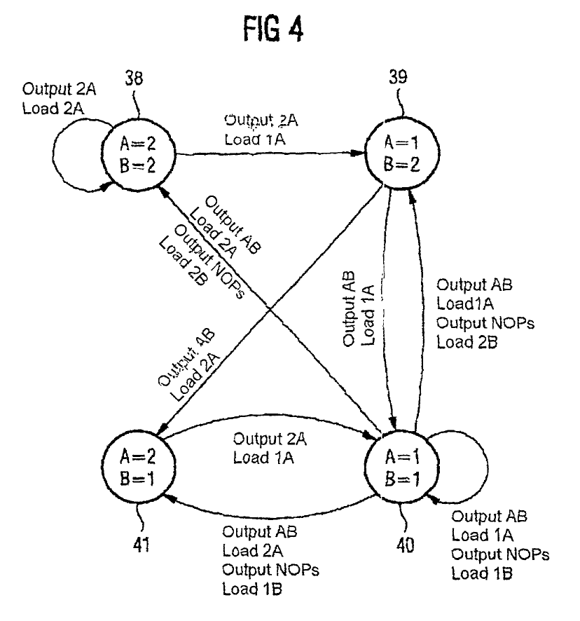

FIG. 4 shows the state diagram of the flow control unit 10. The flow control unit has four different states 38 to 41 which are each distinguished by different values A and B. The values A and B indicate how many instructions are still located in the instruction buffer IA 13 and IB 14. In the illustrated state diagram, the priority of process A is higher than the priority of process B.

It is indicated in the diagram which actions are carried out at each state transition, that is to say one or two of the values A and/or B are output from the instruction buffers IA 13 and/or IB 14 by the instruction issue selector 15, or one or two instructions are loaded or reloaded from the program memory into the instruction buffers IA 13 and/or IB 14. The instruction issue selector 15 can also output NOPs. 2A and 2B indicate that two values are output from the instruction buffer IA or IB or loaded into it, and correspondingly 1A and 1B signifies the outputting or the (re)loading of just one value.

I claim:

1. A data-processing device for processing in parallel a plurality of independent processes, comprising:
a program memory having stored therein at least one compiled program with a multiplicity N of independent processes, the compiled program including information on parallelism and a multiplicity of bundles with a plurality of instructions of a process;
a branching control unit connected to and addressing said program memory;
a register for storing flags and data which are switched in dependence on a process being executed; and
a program flow control unit connected to said branching control unit, said program flow control unit controlling a fetching of bundles from said program memory and said branching control unit and an output of instructions in dependence on information contained in the instructions and included in a compiling time of the program.

2. The data-processing device according to claim 1, which comprises a number N instruction buffers connected in parallel downstream of said program memory for storing instructions read out from said program memory.

3. The data-processing device according to claim 2, which comprises an instruction output selector connected to and controlled by said program flow control unit such that said instruction output selector reads out instructions from said instruction buffers and outputs N instructions in parallel.

4. The data-processing device according to claim 1, which comprises N instruction decoders for decoding the instructions being output.

5. The data-processing device according to claim 1, which comprises at least two instruction-execution units for outputting the N decoded instructions.

6. The data-processing device according to claim 5, which comprises a data memory and at least two buses connecting said N instruction-execution units to said data memory.

7. The data-processing device according to claim 1, wherein said program flow control unit is configured to execute the instructions of one or more bundles in parallel.

8. The data-processing device according to claim 1, wherein said branching control unit is configured to output an address pointer for addressing a bundle.

9. The data-processing device according to claim 1, wherein the branching control unit comprises:
a first multiplexer and a second multiplexer;
an adder; and
N program counters; and
wherein said program flow control unit feeds a number of instructions in a bundle to said adder and said adder adds an address pointer and the number of instructions;
wherein said program flow control unit feeds addresses for program jumps or function calls and a process number to said first multiplexer;
said first multiplexer writing either the output signal of said adder or the addresses for program jumps or function calls into said program counter assigned to the active process; and
a content of said program counter assigned to the currently active process is output as a new address pointer via said second multiplexer which is controlled using the process number supplied.

10. The data-processing device according to claim 1, wherein said program flow control unit is configured to receive via a subbus of an output bus of said program memory at least one of the following:
at least one bit for indicating the parallel execution of instructions;
at least one bit for indicating the length of the following instruction bundle;
the indication of one or more NOPs in the instruction bundles;
a priority of the processes of the instructions.

11. The data-processing device according to claim 1, wherein a process is called by assigning a process number, a priority and a memory address of a starting point of the process in the program memory.

12. The data-processing device according to claim 1, wherein said data-processing device is a network processor for processing layer 1 to 7 of protocol stacks in applications including LAN, ATM switches, IP routers, and frame relays based on a system selected from the group consisting of DSL, Ethernet, and cable modems.
